(19) United States
(12) Patent Application Publication
(10) Pub. No.: US 2013/0275765 A1
(43) Pub. Date: Oct. 17, 2013

(54) SECURE DIGITAL DOCUMENT DISTRIBUTION WITH REAL-TIME SENDER CONTROL OF RECIPIENT DOCUMENT CONTENT ACCESS RIGHTS

(71) Applicant: JAMES FRAZIER LAY, Cherry Log, GA (US)

(72) Inventor: JAMES FRAZIER LAY, Cherry Log, GA (US)

(21) Appl. No.: 13/445,846

(22) Filed: Apr. 12, 2012

(51) Int. Cl. H04L 9/00

(52) U.S. Cl. 713/189

(57) ABSTRACT

A system, method, and computer program product for automatically providing a document sender with full real-time control over a recipient's document content access rights, even after delivery is completed. A sender creates original content and defines access rights for a selected recipient identified by username or email address. The document and rights are encrypted and sent to a server, which transmits a notification to the recipient including instructions on how to acquire the content. The recipient downloads the document content with an embodiment, and may use the received document according to the current access rights, which are verified with a server upon opening the document and may control document viewing, printing, and usage time limits. The sender may alter or revoke access rights at any time, and may monitor recipient document usage in detail. Secondary authentication, electronic commerce, and Bates stamping are enabled for application, enterprise, and point-to-point embodiments.

### FIELD OF THE INVENTION

The present patent application relates in general to secure messaging, and more specifically to a secure digital document control and security application that provides a document sender with full real-time control over a recipient's document content access rights and recipient document usage monitoring capability.

### BACKGROUND OF THE INVENTION

Digital messaging systems have increased sharply in popularity in recent years. Network traffic traditionally comprised emails and internet file transfers, usually by desktop computer users. Such transmission volume is now far surpassed by text messaging and photo sharing. While desktop computers are still used, messaging now often involves mobile devices, such as smartphones with internet connectivity, high-resolution cameras, and color displays.

Most conventional network messaging is based on a “store and forward” transmission philosophy, wherein an original message is packetized and sent via various network connections to a number of intermediate and often public servers. The message then eventually propagates to its recipient, after being handled by a variety of essentially anonymous computers. Such an indirect scheme flexibly avoids many problems with failures of a particular server or network connection, but does introduce some slight delays.

Unfortunately, adoption of this model requires message originators to relinquish control of their transmitted documents to the delivery system and recipients. Even if encryption methods are employed to help prevent interception and alteration of content, ultimately the intended recipient has full possession of the incoming document content. Many senders find encryption key management bothersome, and thus routinely send documents without any encryption at all, often in a spontaneous or even thoughtless manner. The recipient is generally free to use the received document content thereafter, with no practical limitation or recourse available to the sender. Thus, any recipient may freely use, edit, print, and forward the received document content, sometimes with regrettable consequences. The recipient may also deny any viewing or use of the received document content, as there is often no means available for reporting document content access back to a sender.

As a result, there is a need for a secure digital document delivery system, method, and application via computer program product that provides a document sender with full real-time control of a recipient's document content access rights, even after delivery has been completed. Monitoring of a recipient's document access details by a sender is also needed.

### SUMMARY OF THE EMBODIMENTS

A system, method, and computer program product for automatically providing a document sender with full real-time control over a recipient's document content access rights, even after delivery is completed are disclosed and claimed herein.

An exemplary computer-implemented method embodiment comprises creating a document comprising document content and a recipient identifier, encrypting and securely transmitting the document and, separately, recipient document content access right attributes to a server, notifying the recipient of document availability, securely transmitting the encrypted document content to a recipient, and providing the recipient selective access to the document content according to currently verified document content access rights. The document content may comprise digital data including text, images, audio, video, cryptographic keys, URLs, web pages, and/or a packetized stream.

The recipient identifier may comprise a unique recipient username or a recipient email address. The recipient document access rights may be determined by attributes controlling whether the document may be opened, whether the document may be printed, a first allowed document opening date and time, a last allowed document opening date and time, a maximum number of times the document may be opened, and/or whether secondary authorization is required to open the document. The server may notify the recipient of document availability via email or text message, and documents are transmitted to the recipient by the server on request.

The server securely verifies the current document content access rights, which may be modified by a document sender. The method may also comprise reporting document access information to the document sender. The recipient may acquire the document content via purchase and/or rental. The document may be an advertisement, and/or may include a subset of another document. A Bates stamp may be incorporated into the document content.

The server may be in an enterprise. The method may further detect recipient programs capable of subverting document content access rights, and halt its own operation upon such detection.

An exemplary system embodiment may comprise a processor and a memory containing executable instructions to create a document comprising document content and a recipient identifier, encrypt and securely transmit the document and, separately, recipient document content access right attributes to a server, notify the recipient of document availability, securely transmit the encrypted document content to a recipient, and provide the recipient selective access to the document content according to currently verified document content access rights. The server may be an enterprise server.

An exemplary computer program product embodiment may comprise a computer readable medium tangibly embodying non-transitory computer-executable program instructions thereon that when executed cause a computer to create a document comprising document content and a recipient identifier, encrypt and securely transmit the document and, separately, recipient document content access right attributes to a server, notify the recipient of document availability, securely transmit the encrypted document content to a recipient, and provide the recipient selective access to the document content according to currently verified document content access rights.

As described more fully below, the apparatus and processes of the embodiments disclosed permit automatic secure digital document delivery that provides a document sender with full real-time control of a recipient's document content access rights, even after delivery has been completed, and ongoing monitoring of recipient document access details. Further aspects, objects, desirable features, and advantages of the apparatus and methods disclosed herein will be better understood and apparent to one skilled in the relevant art in view of the detailed description and drawings that follow, in which various embodiments are illustrated by way of example. It is to be expressly understood, however, that the drawings are for the purpose of illustration only and are not intended as a definition of the limits of the claimed invention.

### BRIEF DESCRIPTION OF THE DRAWINGS

FIG. 1 depicts an overview of the SafedoX™ application according to an embodiment;

FIG. 2 depicts the setting of secondary authentication features according to an embodiment;

FIG. 3 depicts the setting of attributes governing recipient document content access rights and monitoring controls according to an embodiment;

FIG. 4 depicts the setting of viewable document portions according to an embodiment;

FIG. 5 depicts the setting of an electronic commerce site for document acquisition according to an embodiment;

FIG. 6 depicts a diagram of client-server operations, according to an embodiment;

FIG. 7 depicts a diagram of an enterprise document delivery system, according to an embodiment.

### DETAILED DESCRIPTION OF EXEMPLARY EMBODIMENTS

The overall operation of the various embodiments of the invention are now described in terms of an exemplary software application, typically provided via and/or stored on a computer program product. Note, throughout the description, the term “document” refers to any digital dataset to be communicated from a sender to a recipient via the embodiments. The document comprises document content, including for example a message and any attachments, and may be in any transmission format and be of any content type, including but not limited to text files, text messages, imagery, audio, video, instant messages, cryptographic keys, URLs, web pages, or any packetized stream. The document is always stored and transmitted in a cryptographically secure manner by the application, so the original plaintext version of the sender's document content is not vulnerable. Recipient document content access right attributes are not contained within the document, but are sent to the server separately. The commercially available embodiment, referred to herein as the SafedoX™ application, at present handles only Adobe® Acrobat® format documents, but the invention is not so limited (Adobe® and Acrobat® are registered trademarks of Adobe Systems Incorporated).

Registration

A document recipient who is not yet a registered user of the SafedoX™ service first receives an announcement email denoting that a document originating from a particular sender and protected by the embodiments of the invention is available. The announcement email further provides instructions detailing the necessary steps to open the document, e.g. installing the application, becoming a registered SafedoX™ user, and logging in. The application is currently available free of charge for recipients, to encourage its use and widespread adoption, and is available to senders via subscription.

On the first use of the application, a new user provides a username and a password to the application. The username is typically an email address, as each is unique, but any unique identifier is within the scope of the invention. The user's computer computes a hash of the password, and stores the username locally in a cryptographically secure manner. The hash of the password is not stored in nonvolatile memory, e.g. written to disk on the user's computer.

The user's computer sends the username and the hash of the password (but not the actual password) to a SafedoX™ server in a cryptographically secure manner. HTTPS (SSL) is an exemplary cryptographically secure manner of client-server data exchange employed by embodiments of the invention, though all such methods as may be known in the art are within the scope of the invention. All query-response transactions with the server preferably follow the same protocol. The embodiments may employ an MD5 hash algorithm as a checksum for detection of data transmission errors, but the invention is again not limited to this approach.

Login

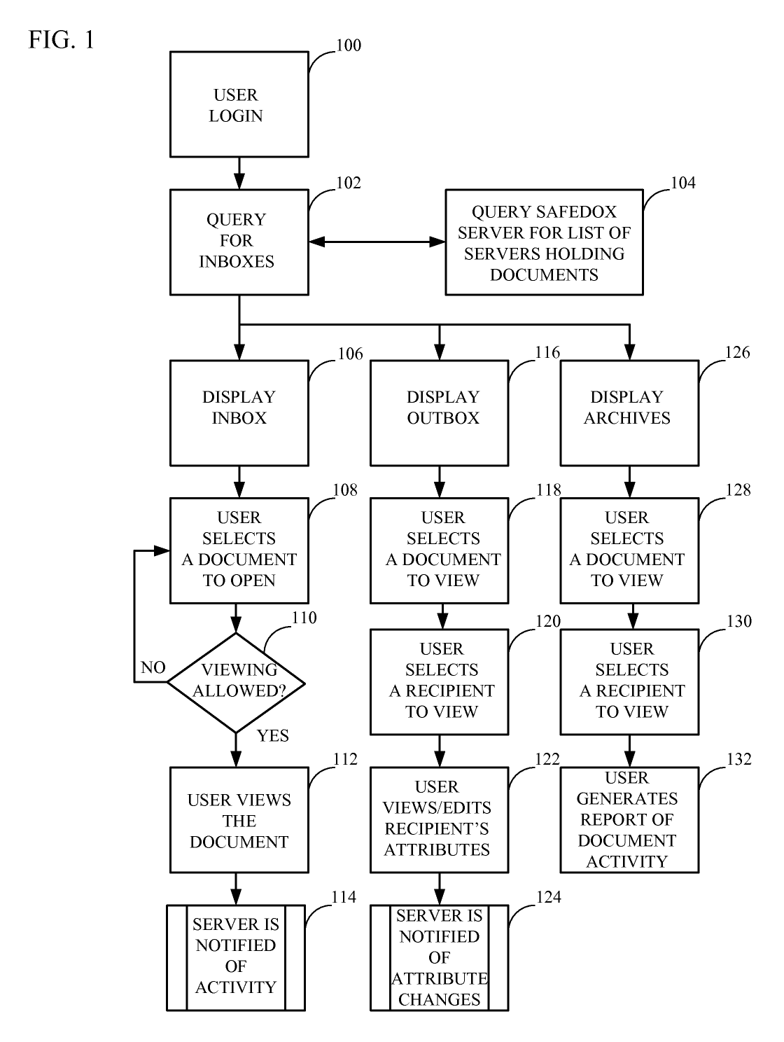

Referring now to FIG. 1, an overview of the SafedoX™ application is shown. The now-registered user provides a username and a password to the application in step 100. The user's computer calculates a hash of the password, and sends the username and a request for a server-calculated password hash to the SafedoX™ server in a cryptographically secure manner. The server uses the username to look up the password hash it has stored from the registration phase, then transmits the stored password hash to the application in a cryptographically secure manner. The application compares the retrieved password hash with the calculated hash of the password input by the user who is attempting to login. If the two hashes match, the user who is attempting to login is authenticated.

Message Reception

Once the user has logged in, in step 102 the application queries the server used to send that specific document for the then-current status of the document as it pertains to this specific recipient. In step 104, a SafedoX™ server checks its list of servers (if any) that are holding documents for the user. The application then receives a list of servers having documents available for the user, and the inventory of messages stored by each.

The application may then fetch from the server (or servers) the current document content access right attributes for any documents for which the user is the intended recipient. In a currently available implementation, these documents are stored only on the server, but generally the documents may also be stored on the user's computer to meet e-discovery requirements. A document is downloaded only if the recipient has valid document content access rights to the document. The application preferably checks to see if documents are available in local storage prior to fetching them from the server. A user can then command the application to display the user's inbox, at step 106, which outwardly resembles the inbox of familiar email applications.

During the download process, documents are broken into packets and encrypted. Note, even if a document is physically stored on the user's computer, the document cannot be viewed without access to the server and without permission from the sender. The only functional difference between the types of material protectable by the embodiments is the actual payload of the data stream being received by the application, and the viewer tool used to render the material.

Unlike conventionally received messages, all documents handled by the embodiments of the present invention may only be accessed by a recipient if the document content access rights granted to the recipient by the sender authorize such access. The sender may revoke or modify any recipient's access rights to a specific document, or all the sender's documents, at any time. Thus, the embodiments permanently provide the sender with control of the documents transmitted thereby.

This is depicted in steps 108 and 110, in which a user selects a document to open and the application checks to determine if the document's attributes denote proper document content access rights. If not, the document is not made available and operation returns to step 108. If the document content access rights allow, the user views the document in step 112. The server is notified of the recipient's activity with the document in step 114.

Documents that are opened remain cryptographically secure, with only a particular displayed page being decrypted and stored in volatile memory of a recipient's computer at a time, for display and possible printing purposes. The commercially available embodiment has employed an RC4 stream cipher for internal cryptographic data security, but any cryptographic method is within the scope of the invention. The application may not execute or open documents if the user's computer executes a screen capture tool or other tool known to generate a forensic copy of memory contents. Similarly, a document may be printed only if it is opened and if the access rights for the particular document and recipient authorize printing.

Secondary Authentication

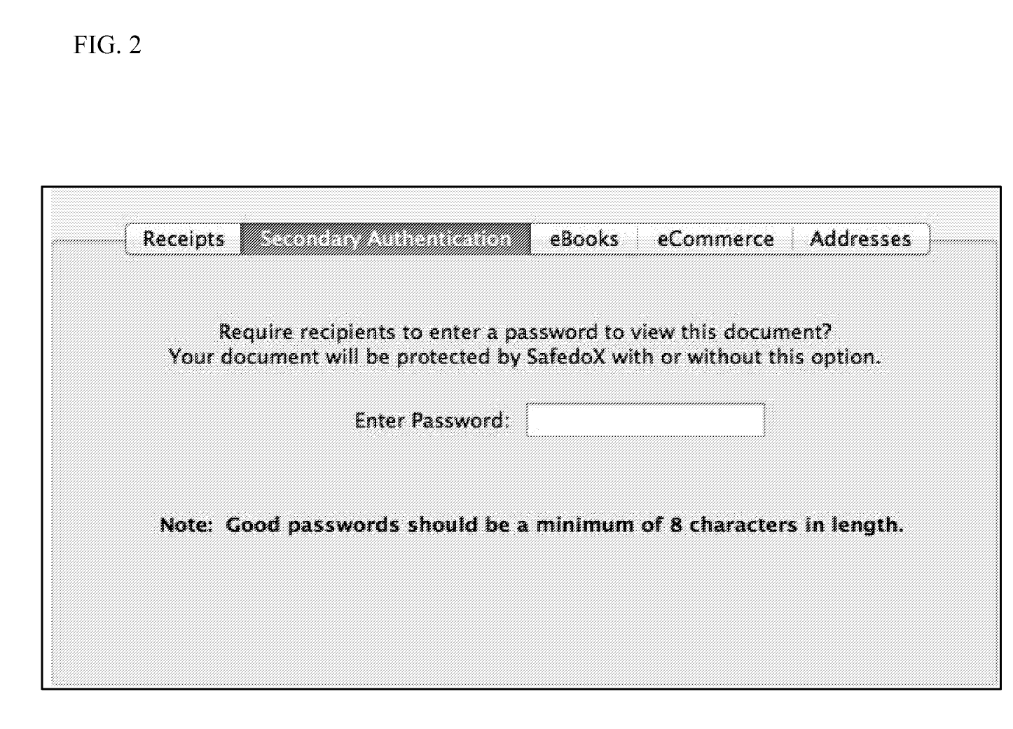

In some circumstances, documents are required to be password protected, such that anyone who receives the document must provide a password to view it. Such so-called secondary authentication is required in addition to any other security conditions. Secondary authentication is often necessary to meet certain document content access compliance regulations for the human resources or medical professions, such as HIPPA (Health Insurance Portability and Accountability Act of 1996). Embodiments of the invention thus will not open a delivered document under these circumstances until a recipient provides the correct password, which may be specific to a particular document and/or recipient with a “need to know” the document content. This is depicted in FIG. 2.

Sending and Monitoring Messages

A sender may compose documents in a document viewing and email preparation window of familiar appearance, shown in FIG. 1 step 116. The embodiments of the present invention enable the sender to also specify access right details for a particular document (selected in step 118) and recipient or recipient group (selected in step 120). The access right details may be viewed and set in the sender's outbox, shown at step 122. The server is then securely notified of such recipient document content access right attributes in step 124. The document will be stored locally and subsequently broken into packets for separate secure transmission to the appropriate server along with the list of recipients. The servers are updated to reflect that there is now a document pending delivery to this recipient on the user's domain server or on the SafedoX™ server if no domain is present.

Sender-server transactions preferably use a sender-specific encryption key, so the sender's documents always remain keyed to the recipient. The application preferably generates a cryptographically different instance of each particular document sent to each particular recipient. In this way, each delivered document will be fully customized. Access right attributes are not written to local storage on a recipient's computer, instead only a secure link to the server is locally stored.

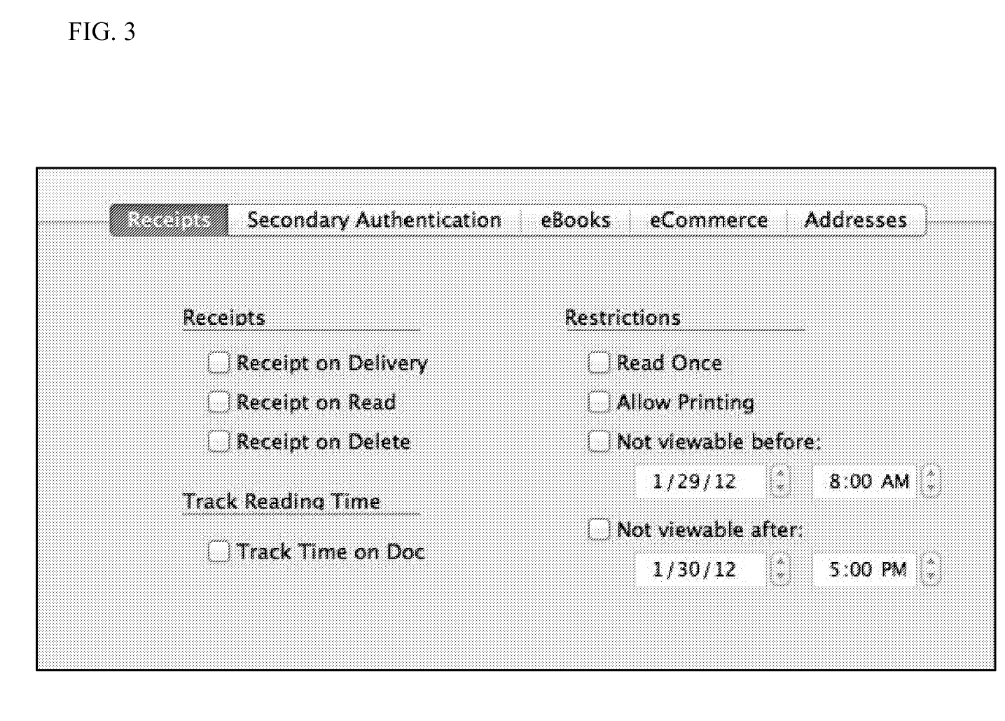

The sender may effectively specify a range of dates and times when a particular document may be opened. In other words, the sender may specify dates and times when a particular document may first be opened, or when a particular document may no longer be opened, or both. If the current date and time is not within the range of valid document opening dates and times defined according to the sender's specifications, the document may not be opened. This is depicted in FIG. 3.

These features may be of particular utility in managing the timing of press releases or other time-sensitive announcements, and for controlling the availability of subscription-based services. The application preferably gathers current time data from a variety of networked input sources, to prevent recipient clock tampering from bypassing sender-specified document content access right constraints. The date and time restrictions are preferably specified in terms of the recipient's local time, though the invention is not so limited.

Time-sensitive documents may typically include corporate earnings announcements or other press releases, legal documents such as warranties or protective orders, and electronic commerce related documents such as advertisements and coupons for example. Rented content such as games, movies, and music for example may also be managed via embodiments of the present invention.

The sender may also specify a maximum number of times that a recipient may open a particular document. The sender may also specify whether a recipient may print a particular document as previously mentioned; the exemplary default setting is that printing is not allowed. Recipients cannot forward documents, nor generally cut-and-paste document content into another document. Senders may archive documents to storage as shown in FIG. 1 steps 126-132, but recipients may not archive documents.

Embodiments of the present invention also enable a sender to receive receipts denoting when a particular transmitted document was received by a recipient, when it was first opened, and when it was deleted for example. Further, the sender may receive data enabling tracking of the time a recipient had a particular document open. Such tracking may be performed on a page-by-page basis, so that a sender has detailed recorded knowledge of the recipient's use of the document.

Such monitoring information is currently provided to the sender, via a server, when a document is closed by the recipient, but the invention is not so limited. In a commercially available implementation, document content access rights are verified when a recipient attempts to open a document, but the invention is again not so limited. The choice to verify document content access rights upon opening a document is based on network bandwidth considerations. In high security scenarios, more frequent access right verification may be selected, and open documents may be closed if access rights become invalid.

eBooks

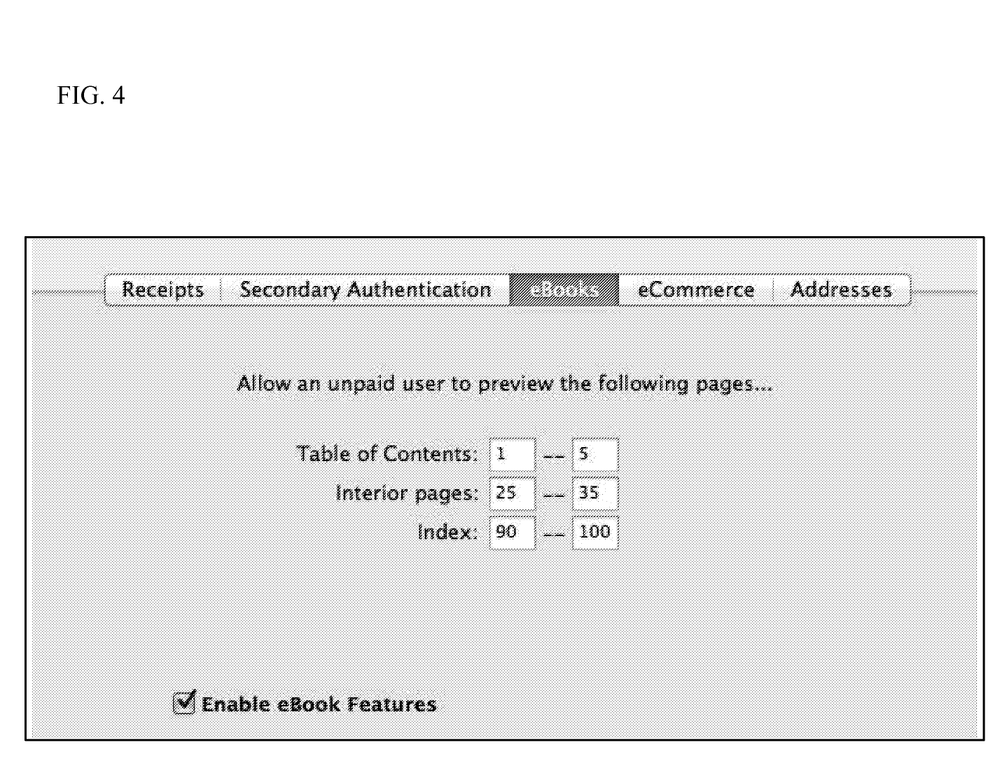

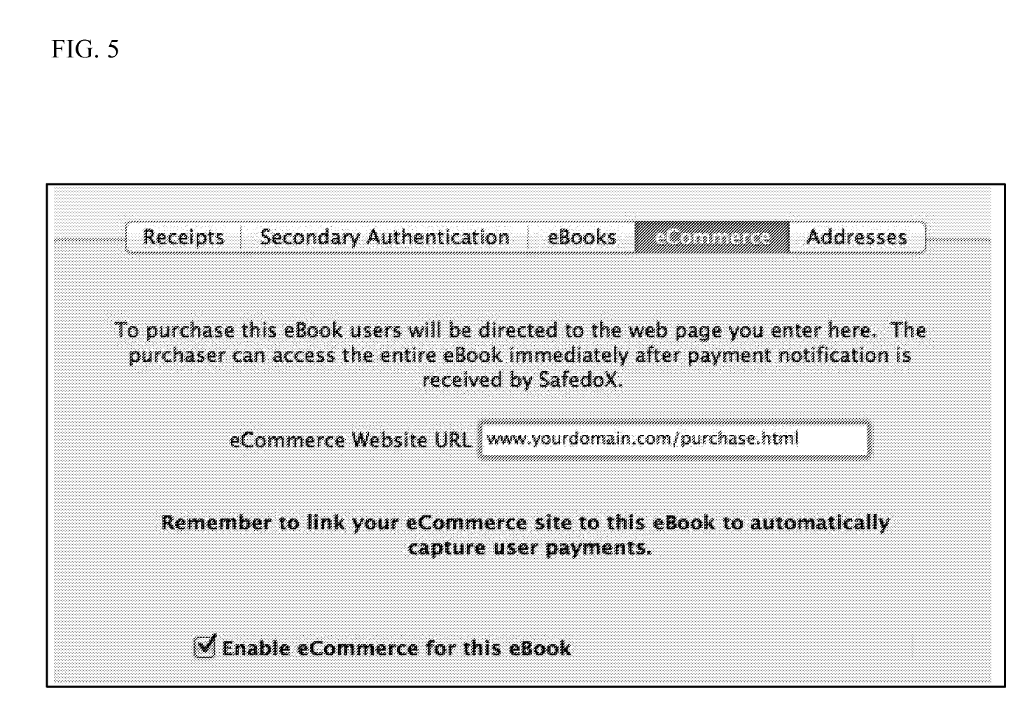

Documents may be made available by the sender for purchase by a recipient. An advertising document may be sent to a recipient via embodiments of the invention. As shown in FIG. 4, a sender may set document attributes to allow a recipient of an advertising document to view selected portions of such a document, such as the table of contents, some interior pages, or an index for example. Similarly, the document may include selected portions of a movie, or any other supported document type. The “preview” document may include a URL if the sender wishes, to enable a recipient to purchase the full document online, as shown in FIG. 5. The purchased document may be delivered via another message, with selected document content access rights (view-only for example, i.e. no printing allowed, or viewing allowed only for a certain range of dates and times) as specified in the purchase request.

eCommerce

An alternate use is to enable direct billing from a vendor to a purchaser using embodiments of the present invention. For example, an invoice including an embedded payment URL may be emailed directly from a doctor's office to a patient, and/or a payment message may be sent directly to a credit card processor. In this case, the document itself is not being purchased, it merely provides a record of and payment means for a related transaction.

Bates Stamping

A visible serial number may be added by a sender to a document involved in litigation, so that particular documents in a controversy may be readily identified. The application may calculate a hash of each document's page, then later compare two pages by comparing the hash values to determine if the pages are identical (i.e. even a single pixel's difference would result in different hash values).

Server Transactions

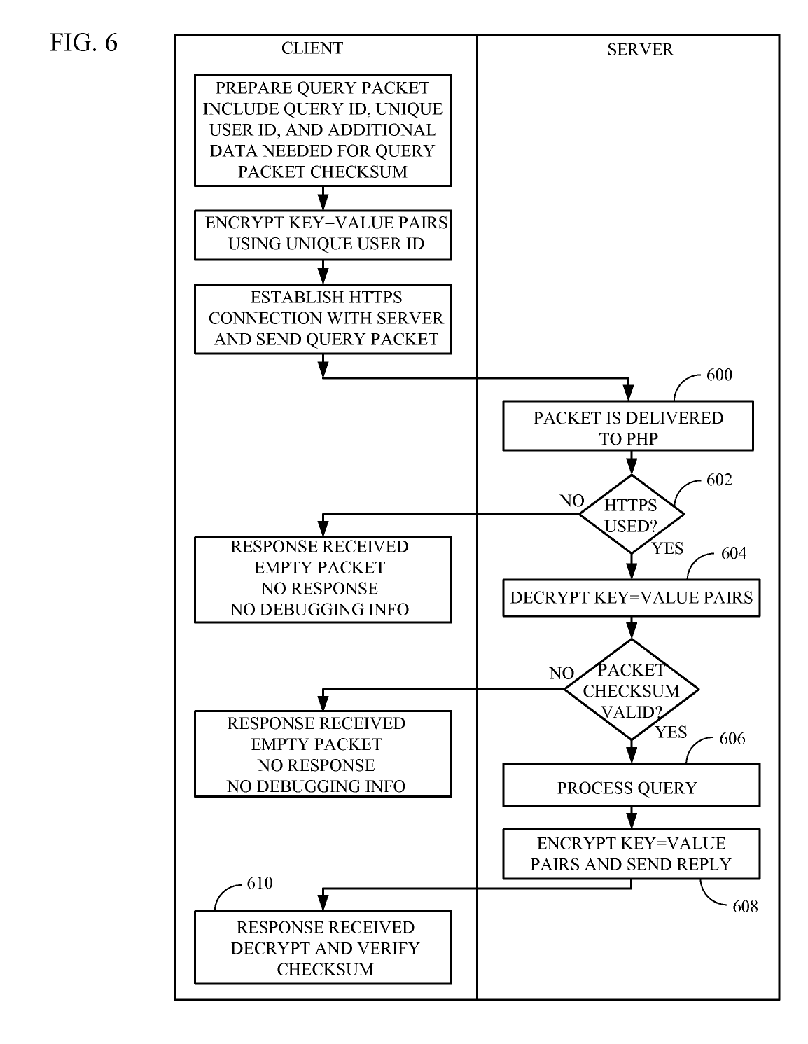

Referring now to FIG. 6, client-server operations of the embodiments are shown. The communications between the application and the server are currently handled via HTTPS. SSL, the cryptographic layer utilized in HTTPS, operates at the ISO Transport Layer, one layer below the Application Layer. Since the Application Layer would have important data momentarily exposed in the program memory while awaiting the handoff to the Transport Layer, the application encrypts the data as soon as possible while the data is still within the Application Layer. This encryption is currently done using the RC4 stream cipher and the key is user-specific. Once encrypted at the Application Layer, the data is collected into a key=value pair for delivery to the server via HTTPS (SSL).

The actual transaction takes place in two steps. The key=value data stream is sent to the server via a POST to a PHP page in step 600. If the connection has not been established using secure HTTPS, the server refuses the connection in step 602. Once the data packet has been received, the contents are decrypted in step 604 using the same key used to encrypt the internal data before sending the transaction to the server. The contents of the transaction packet include the user id of the entity requesting the transaction, the id of the query being requested and any specific data elements required to process the transaction. The transaction is then executed on the server in step 606 based on the value passed in the transaction packet.

Any response to be returned to the application will first be encrypted in step 608 using the internal packet key for this user. Once the response data has been encrypted, it is returned to the requesting application in step 610. This return stream is still an HTTPS connection using SSL as its cryptographic layer. This technique effectively doubles the level of computational capacity required to decrypt a transaction that might be intercepted while in transport via the Internet. Even though SSL is considered to be a cryptographically secure protocol this double-layer of encryption is a further deterrent to data compromise.

There are many query-response transactions with the server similar to the one just described. These transactions cover everything from the login exchange to sending and receiving of documents. The transactions preferably all follow the same sequence shown in FIG. 6.

### Enterprise Embodiments

The description of embodiments of the present invention provided above have been in terms of a software application that a user installs and executes on a local computer. The application contacts a SafedoX™ server (or, indirectly, a set of domain servers) to acquire and send documents. The application includes a document viewer tool and a communications tool that handles encrypted client-server exchanges. The application may be enabled via time-based subscription for a fee.

In some instances though, users may wish to employ the features described in an embodiment that provides more control over their data. Enterprise customers may therefore configure a private system for sending documents in their own enterprise domain. An enterprise may comprise any organization, but typically refers to a company or a government, or subdivisions thereof.

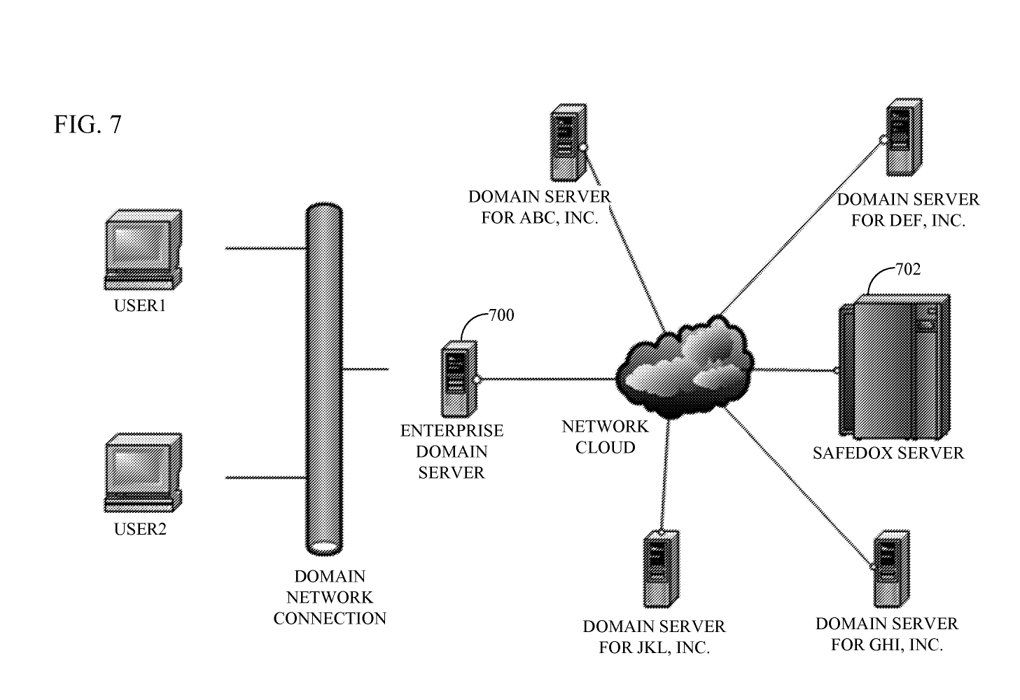

Expanding the SafedoX™ system to accommodate enterprise users requires few changes. The enterprise domain server 700 shown in FIG. 7 is a clone of the SafedoX™ server previously described, with a single distinction: the enterprise domain server will update the SafedoX™ server 702 with new user accounts as they are added to the domain. This allows the SafedoX™ server to determine whether a username is already in use and, if so, the address of its domain server. Without this master list of usernames, there is an opportunity for duplication of usernames that would cause errors in the delivery and display of documents to and from that username/account.

When a user (for example, in this case user1) requests a list of current, undelivered documents, the application will first contact the SafedoX™ server. This request will be for a list of all enterprise domain servers holding inbox documents for this user. The application will then contact each domain server directly and request the inbox list from that server. From this point the behavior is identical to non-enterprise configurations: A user requests a document from a server, it is downloaded, etc.

Also, in enterprise configurations, if the recipient is part of the enterprise domain of the sender (user2, in this case) the SafedoX™ server will not be involved in the transaction. The enterprise domain server will handle the entire process. Otherwise, an entry will be created in the SafedoX™ server's database that indicates this specific enterprise's server is holding an inbox document for the recipient.

Functions provided by the separate software application in the previously described embodiments may instead be seamlessly integrated with existing enterprise programs, such as web browsers and email tools. Requests to store a document, send an email, or otherwise transfer a file may be intercepted and passed through the enterprise embodiment for processing.

Point-to-Point Secure Messaging

Embodiments of the present invention may also enable a point-to-point secure messaging process with similar attribute-based permissions as currently applied to documents. A sender would be able to choose the recipient(s) and the manner in which permission to view the message would be granted or revoked.

As used herein, the terms “a” or “an” shall mean one or more than one. The term “plurality” shall mean two or more than two. The term “another” is defined as a second or more. The terms “including” and/or “having” are open ended (e.g., comprising). Reference throughout this document to “one embodiment”, “certain embodiments”, “an embodiment” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics may be combined in any suitable manner on one or more embodiments without limitation. The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

In accordance with the practices of persons skilled in the art of computer programming, embodiments are described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, the elements of the embodiments are essentially the code segments to perform the necessary tasks. The non-transitory code segments may be stored in a processor readable medium or computer readable medium, which may include any medium that may store or transfer information. Examples of such media include an electronic circuit, a semiconductor memory device, a read-only memory (ROM), a flash memory or other non-volatile memory, a floppy diskette, a CD-ROM, an optical disk, a hard disk, a fiber optic medium, a radio frequency (RF) link, etc. User input may include any combination of a keyboard, mouse, touch screen, voice command input, etc. User input may similarly be used to direct a browser application executing on a user's computing device to one or more network resources, such as web pages, from which computing resources may be accessed.

While the invention has been described in connection with specific examples and various embodiments, it should be readily understood by those skilled in the art that many modifications and adaptations of the invention described herein are possible without departure from the spirit and scope of the invention as claimed hereinafter. Thus, it is to be clearly understood that this application is made only by way of example and not as a limitation on the scope of the invention claimed below. The description is intended to cover any variations, uses or adaptation of the invention following, in general, the principles of the invention, and including such departures from the present disclosure as come within the known and customary practice within the art to which the invention pertains.

What is claimed is:

1. A computer-implemented method, comprising:
creating a document comprising document content and a recipient identifier;
encrypting and securely transmitting the document and document content access right attributes to a server;
notifying the recipient of document availability;
securely transmitting the encrypted document content to a recipient; and
providing the recipient selective access to the document content according to currently verified document content access rights.

2. The method of claim 1 wherein the document content comprises digital data including at least one of text, images, audio, video, cryptographic keys, URLs, web pages, and a packetized stream.

3. The method of claim 1 wherein the recipient identifier comprises at least one of a unique recipient username and a recipient email address.

4. The method of claim 1 wherein the recipient's document access rights are determined by attributes controlling at least one of whether the document may be opened, whether the document may be printed, a first allowed document opening date and time, a last allowed document opening date and time, a maximum number of times the document may be opened, and whether secondary authorization is required to open the document.

5. The method of claim 1 wherein the server performs the notifying via at least one of email and text message.

6. The method of claim 1 wherein the server performs the transmitting.

7. The method of claim 1 wherein the server securely verifies the current document content access rights.

8. The method of claim 1 further comprising a document sender modifying the current document content access rights.

9. The method of claim 1 further comprising reporting document access information to a document sender.

10. The method of claim 1 wherein the recipient acquires the document content via at least one of purchase and rental.

11. The method of claim 10 wherein the document is an advertisement.

12. The method of claim 10 wherein the document is a subset of another document.

13. The method of claim 1 further comprising incorporating a Bates stamp into the document content.

14. The method of claim 1 wherein the server is in an enterprise.

15. The method of claim 1 wherein the document and the document content access right attributes are encrypted and transmitted separately.

16. The method of claim 1 wherein the securely transmitting employs HTTPS.

17. A system, comprising:
a processor; and
a memory containing executable instructions to:
create a document comprising document content and a recipient identifier;
encrypt and securely transmit the document and document content access right attributes to a server;
notify the recipient of document availability;
securely transmit the encrypted document content to a recipient; and
provide the recipient selective access to the document content according to currently verified document content access rights.

18. The system of claim 17 wherein the server is at least one of an enterprise server and the recipient's computer.

19. A computer program product comprising a computer readable medium tangibly embodying non-transitory computer-executable program instructions thereon that when executed cause a computer to:
create a document comprising document content and a recipient identifier;
encrypt and securely transmit the document and document content access right attributes to a server;
notify the recipient of document availability;
securely transmit the encrypted document content to a recipient; and
provide the recipient selective access to the document content according to currently verified document content access rights.

20. A system, comprising means for:
creating a document comprising document content and a recipient identifier;
encrypting and securely transmitting the document and document content access right attributes to a server;
notifying the recipient of document availability;
securely transmitting the encrypted document content to a recipient; and
providing the recipient selective access to the document content according to currently verified document content access rights.
